(19) United States
(12) Patent Application Publication
(10) Pub. No.: US 2026/0045840 A1
(43) Pub. Date: Feb. 12, 2026

(54) ROTOR FOR MOTOR

(71) Applicant: HYUNDAI MOBIS CO., LTD., Seoul (KR)

(72) Inventor: Yeong Woo SEO, Yongin-si (KR)

(73) Assignee: HYUNDAI MOBIS CO., LTD., Seoul (KR)

(21) Appl. No.: 19/241,495

(22) Filed: Jun. 18, 2025

(30) Foreign Application Priority Data
Aug. 6, 2024 (KR) 10-2024-0104669
Sep. 13, 2024 (KR) 10-2024-0126066

(51) Int. Cl. H02K 1/276; H02K 1/28

(52) U.S. Cl. CPC H02K 1/276; H02K 1/28

(57) ABSTRACT

Disclosed is a rotor including a core body having an insertion space S therein, and a magnet member inserted into the insertion space S, in which a tab portion is formed on an inner surface of the core body or one side surface of the magnet member that defines a boundary of the insertion space S, and the tab portion protrudes toward a space of the insertion space S other than a space into which the magnet member is inserted.

### CROSS-REFERENCE TO RELATED APPLICATION

This application claims priority to and the benefit of Korean Patent Application No. 10-2024-0104669 filed in the Korean Intellectual Property Office on Aug. 6, 2024, and Korean Patent Application No. 10-2024-0126066 filed in the Korean Intellectual Property Office on Sep. 13, 2024, the entire contents of which are incorporated herein by reference.

### TECHNICAL FIELD

The present disclosure relates to a rotor for a motor.

### BACKGROUND ART

A rotor for a motor sometimes has a portion that is referred to as a rib configured to surround an outer surface of the rotor in order to prevent separation of a magnet. The rotor having the rib has a problem in that magnetic flux leaks, which degrades operational efficiency of the motor. In general, in order to prevent the problem, a method is used that removes the rib and winds a material, such as carbon fiber, around the outer surface of the rotor.

However, in case that the material, such as carbon fiber, is wound around the outer surface of the rotor in the related art, there is a problem in that a radial thickness of the rotor is increased by a region around which the material is wound, and manufacturing costs for the rotor are also increased.

### SUMMARY

The present disclosure has been made in an effort to provide a novel rotor structure capable of suppressing an increase in radial thickness of a rotor while preventing a problem of a leak of magnetic flux.

In order to achieve the above-mentioned object, one aspect of the present disclosure provides a rotor including: a core body having an insertion space S therein; and a magnet member inserted into the insertion space S, in which a tab portion is formed on an inner surface of the core body or one side surface of the magnet member that defines a boundary of the insertion space S, and the tab portion protrudes toward a space of the insertion space S other than a space into which the magnet member is inserted.

The rotor may further include: a filling member configured to fill at least a part of the space of the insertion space S other than the space into which the magnet member is inserted, in which the filling member is provided to surround the tab portion.

The tab portion may include a magnet side tab portion provided on one side surface of the magnet member and protruding toward the space of the insertion space S other than the space into which the magnet member is inserted.

The insertion space S may include: a main space S1 that is a space occupied by the magnet member; an outer space S2 formed outward of the main space S1; and an inner space S3 formed inward of the main space S1, and the magnet side tab portion may protrude from an end of the magnet member that faces the inner space S3.

A direction in which the magnet side tab portion protrudes may be parallel to a direction in which the main space S1 extends.

The insertion space S may include: a main space S1 that is a space occupied by the magnet member; an outer space S2 formed outward of the main space S1; and an inner space S3 formed inward of the main space S1, and the magnet side tab portion may protrude from an end of the magnet member that faces the outer space S2.

The tab portion may include a core side tab portion formed on the inner surface of the core body that defines the boundary of the insertion space S, and the core side tab portion may protrude toward the space of the insertion space S other than the space into which the magnet member is inserted.

The insertion space S may include: a main space S1 that is a space occupied by the magnet member; an outer space S2 formed outward of the main space S1; and an inner space S3 formed inward of the main space S1, and the core side tab portion may include a core side outer tab protruding from the inner surface of the core body that defines the outer space S2.

A direction in which the core side outer tab protrudes may intersect a direction in which the main space S1 extends.

The core side outer tab may be provided as two core side outer tabs protruding from the inner surface that defines one outer space S2, and the two core side outer tabs may protrude in a direction in which the two core side outer tabs are directed toward each other.

The insertion space S may include: a main space S1 that is a space occupied by the magnet member; an outer space S2 formed outward of the main space S1; and an inner space S3 formed inward of the main space S1, and the core side tab portion may include a core side inner tab protruding from the inner surface of the core body that defines the inner space S3.

A direction in which the core side inner tab protrudes may be parallel to a circumferential direction C that surrounds a rotation axis A of the core body.

The core body may be formed integrally.

The magnet member may be provided as a plurality of magnet members spaced apart from one another in a circumferential direction C that surrounds a rotation axis A of the core body, and the plurality of magnet members may be disposed such that regions in which the two magnet members disposed adjacent to each other in the circumferential direction C are closest to each other are alternately formed at i) inner ends of the magnet members and ii) outer ends of the magnet members in the circumferential direction C.

In a section in which the region in which the two magnet members disposed adjacent to each other in the circumferential direction C are closest to each other is formed at the inner ends of the magnet members, the inner space S3, which is formed in the insertion space S into which one of the two magnet members is inserted, and the inner space S3, which is formed in the insertion space S into which the other of the two magnet members is inserted, may be formed to be spaced apart from each other in the circumferential direction C.

The insertion space S may include: a main space S1 that is a space occupied by the magnet member; an outer space S2 formed outward of the main space S1; and an inner space S3 formed inward of the main space S1, the core side tab portion may include a core side inner tab protruding from the inner surface of the core body that defines the inner space S3, and the core side inner tab may protrude in a direction away from another inner space S3 formed adjacent, in the circumferential direction C, to the inner space S3 in which the core side inner tab is formed.

The rotor may further include: a shaft member inserted into an axial space formed along a rotation axis A of the core body, in which the shaft member has a shaft groove having a recessed shape and formed in a circumferential direction C that surrounds the rotation axis A, in which a part of the filling member is formed on an outer surface of the core body, and in which a part of a region of the filling member formed on the outer surface of the core body is inserted into the shaft groove.

The shaft member may have a shaft protrusion region having a protruding shape and formed in the circumferential direction C, and a part of the region of the filling member formed on the outer surface of the core body may be provided to be tightly attached to the shaft protrusion region.

The region of the filling member tightly attached to the shaft protrusion region may be provided to be tightly attached to an outer surface of the shaft protrusion region in a radial direction R perpendicularly intersects the rotation axis A.

The filling member may contain an adhesive plastic material.

According to the present disclosure, it is possible to manufacture the rotor with a novel structure capable of suppressing an increase in radial thickness of the rotor while preventing a problem of a leak of magnetic flux.

### BRIEF DESCRIPTION OF THE DRAWINGS

FIG. 1 is a perspective view of a rotor for a motor according to the present disclosure.

FIG. 2 is an exploded perspective view of the rotor in FIG. 1 in an embodiment of the present disclosure.

FIG. 3 is a cross-sectional view illustrating a state in which the rotor in FIG. 1 is cut in a direction perpendicular to a rotation axis in the embodiment of the present disclosure.

FIG. 4 is an enlarged view illustrating a magnet member in FIG. 3 and a peripheral region of the magnet member in the embodiment of the present disclosure.

FIG. 5 is an enlarged view illustrating the magnet member and the peripheral region of the magnet member in a state in which a filling member in FIG. 3 is removed in the embodiment of the present disclosure.

FIG. 6 is a perspective view of a shaft member in FIG. 1 in the embodiment of the present disclosure.

FIG. 7 is a cross-sectional view illustrating a state in which the rotor in FIG. 1 is cut in a direction including the rotation axis in the embodiment of the present disclosure.

FIG. 8 is an exploded perspective view of the rotor in FIG. 1 in another embodiment of the present disclosure.

FIG. 9 is a view illustrating a state in which the rotor in FIG. 1 is cut in the direction perpendicular to the rotation axis in another embodiment of the present disclosure.

FIG. 10 is an enlarged view illustrating the magnet member in FIG. 3 and the peripheral region of the magnet member in another embodiment of the present disclosure.

FIG. 11 is a view for explaining an insertion space and a filling space defined by an inner core region and an outer core region of a core body in another embodiment of the present disclosure.

FIG. 12 is a cross-sectional view illustrating a state in which the rotor in FIG. 1 is cut in the direction including the rotation axis in another embodiment of the present disclosure.

### DETAILED DESCRIPTION

Hereinafter, a rotor for a motor according to the present disclosure will be described with reference to the drawings.

### Rotor for Motor

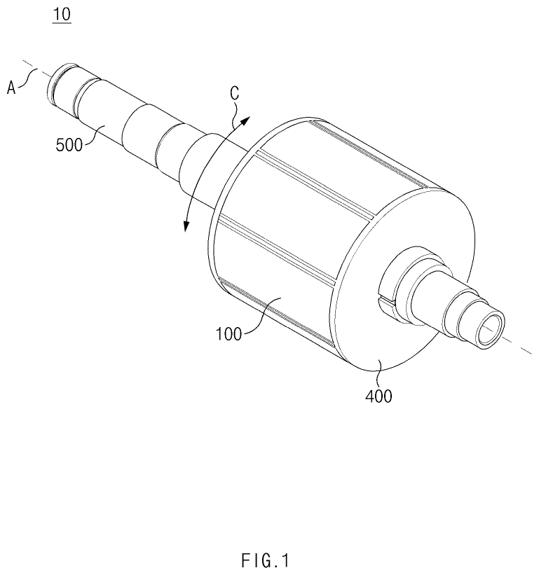

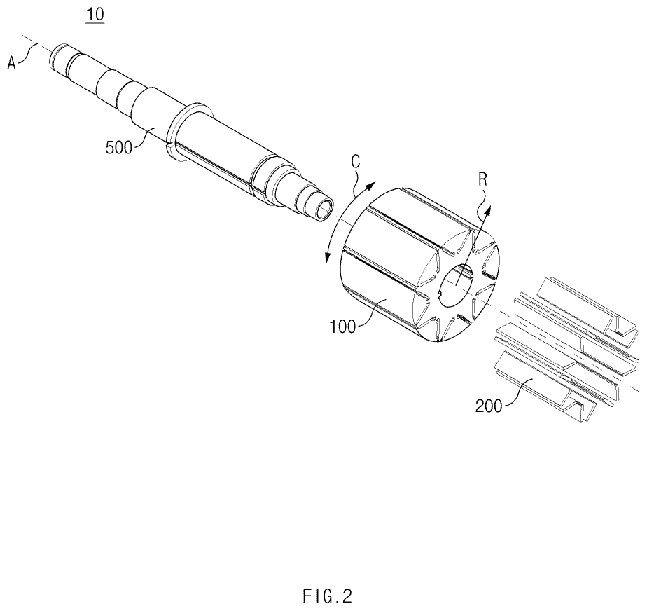

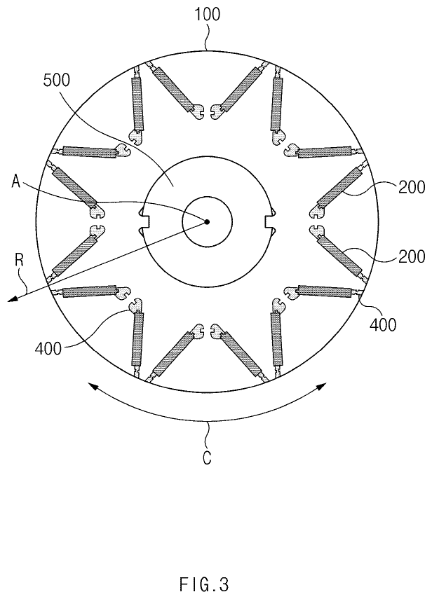

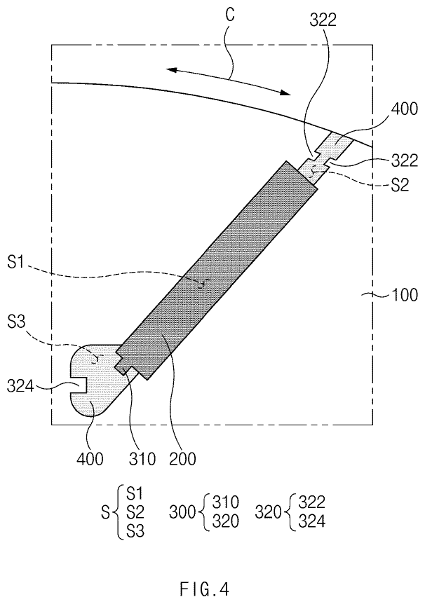

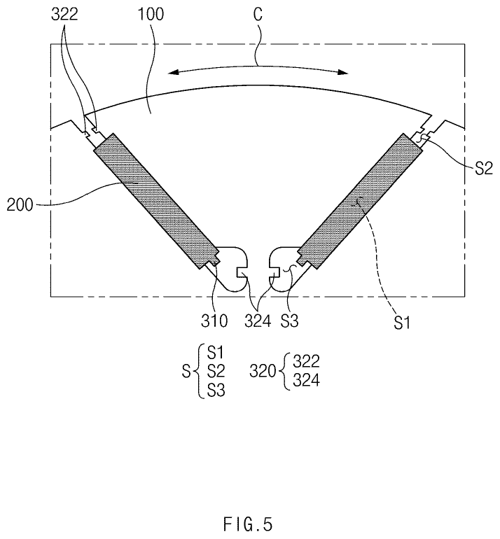

FIG. 1 is a perspective view of a rotor for a motor according to the present disclosure, and FIG. 2 is an exploded perspective view of the rotor in FIG. 1 in an embodiment of the present disclosure. FIG. 3 is a cross-sectional view illustrating a state in which the rotor in FIG. 1 is cut in a direction perpendicular to a rotation axis in the embodiment of the present disclosure, and FIG. 4 is an enlarged view illustrating a magnet member in FIG. 3 and a peripheral region of the magnet member in the embodiment of the present disclosure. FIG. 5 is an enlarged view illustrating the magnet member and the peripheral region of the magnet member in a state in which a filling member in FIG. 3 is removed in the embodiment of the present disclosure.

With reference to FIGS. 1 to 5, a rotor 10 for a motor (hereinafter, referred to as a ‘rotor’) according to the present disclosure may include a core body 100 having insertion spaces S therein, and magnet members 200 inserted into the insertion spaces S. For example, the magnet member 200 may be a permanent magnet. More specifically, the insertion spaces S may be provided as a plurality of insertion spaces S provided in a circumferential direction C of the rotor 10.

In addition, the rotor 10 according to the present disclosure may further include filling members 400 configured to fill at least some of the insertion spaces S. More specifically, at least a part of the space of the insertion space S, other than a space into which the magnet member 200 is inserted, may be filled with the filling member 400. More particularly, the substantially entire space of the insertion space S, except for the space into which the magnet member 200 is inserted, may be filled with the filling member 400.

The filling member 400 according to the present disclosure may serve to fix the magnet member 200 to the core body 100. In order to exhibit the above-mentioned function, the filling member 400 may be provided to surround one side of the magnet member 200. In addition, as described below, a partial region of the filling member 400 may be provided to be tightly attached to an outer surface of the core body 100. In this case, the filling member 400 may serve as a plate or retainer that is a component for supporting a core body of a rotor in the related art.

With continued reference to FIGS. 1 and 2, the rotor 10 according to the present disclosure may further include a shaft member 500 inserted into an axial space extending along a rotation axis A of the core body 100. More specifically, the core body 100 may be fixed to the shaft member 500. Meanwhile, the above-mentioned rotation axis A may be considered the rotation axis for the shaft member 500 and the rotor 10 as well as the core body 100.

Meanwhile, according to the present disclosure, a tab portion 300 may be formed on an inner surface of the core body 100 or one side surface of the magnet member 200 that defines a boundary of the insertion space S. The tab portion 300 may protrude toward the space of the insertion space S other than the space into which the magnet member 200 is inserted.

The tab portion 300 according to the present disclosure may be configured to increase a fixing force by which the filling member 400 is fixed to the magnet member 200 or the core body 100. More specifically, the filling member 400 may contain or be made of an adhesive plastic material. More particularly, the filling member 400 may contain or be made of an adhesive plastic material that is a curable material and has fluidity before the material is cured.

The rotor 10 according to the present disclosure may be manufactured by inserting the magnet members 200 into the insertion spaces S formed by the core body 100, filling the insertion spaces S with the filling members 400 having fluidity, and then curing the filling members 400. In this case, the tab portion 300 may serve to prevent the filling member 400 from separating during the process of curing the filling member 400, thereby increasing a coupling force between the filling member 400 and the magnet member 200 or between the filling member 400 and the core body 100. In order for the tab portion 300 to exhibit the above-mentioned function, the filling member 400 may be provided to surround the tab portion 300.

Meanwhile, with reference to FIGS. 3 to 5, a portion of the tab portion 300, which protrudes from the magnet member 200, may be referred to as a magnet side tab portion 310. More specifically, the tab portion 300 may include the magnet side tab portion 310 provided on one side surface of the magnet member 200 and protruding toward the space of the insertion space S other than the space into which the magnet member 200 is inserted. Hereinafter, the magnet side tab portion 310 will be described in detail.

According to the present disclosure, the insertion space S may be divided into a plurality of spaces. More specifically, the insertion space S may include a main space S1 that is a space occupied by the magnet member 200, an outer space S2 formed outward of the main space S1, and an inner space S3 formed inward of the main space S1. In this case, as illustrated in FIGS. 3 to 5, according to an example of the present disclosure, the magnet side tab portion 310 may protrude from an end of the magnet member 200 that faces the inner space S3. More specifically, the magnet side tab portion 310 may define a part of a boundary of the inner space S3. For example, as illustrated in FIGS. 3 to 5, a direction in which the magnet side tab portion 310 protrudes may be parallel to a direction in which the main space S1 extends. However, unlike the configuration illustrated in FIGS. 3 to 5, according to another example of the present disclosure, the magnet side tab portion 310 may protrude from an end of the magnet member 200 that faces the outer space S2.

With continued reference to FIGS. 3 to 5, a portion of the tab portion 300, which protrudes from the core body 100, may be referred to as a core side tab portion 320. More specifically, the tab portion 300 may include the core side tab portion 320 provided on the inner surface of the core body 100, which defines the boundary of the insertion space S, and protruding toward the space of the insertion space S other than the space into which the magnet member 200 is inserted.

In this case, according to the present disclosure, the core side tab portion 320 may protrude toward the outer space S2 or the inner space S3. More specifically, the core side tab portion 320 may include a core side outer tab 322 protruding toward the outer space S2 from the inner surface of the core body 100 that defines the outer space S2, or a core side inner tab 324 protruding from the inner surface of the core body 100 that defines the inner space S3. FIGS. 3 to 5 illustrate that the core side tab portion 320 includes both the core side outer tab 322 and the core side inner tab 324. The core side outer tab 322 may not only serve to prevent the filling member 400 from separating during the process of curing the filling member 400 but also serve to prevent the magnet member 200 from separating outward during a process in which the rotor 100 rotates in the motor.

Meanwhile, for example, a direction in which the core side outer tab 322 protrudes and a direction in which the core side inner tab 324 protrudes may be different from each other. More specifically, the direction in which the core side outer tab 322 protrudes may intersect the direction in which the main space S1 extends, whereas the direction in which the core side inner tab 324 protrudes may be parallel to the circumferential direction C that surrounds the rotation axis A of the core body 100. For example, as illustrated in FIGS. 3 to 5, two core side outer tabs 322 may protrude from the inner surface that defines the outer space S2, and the two core side outer tabs 322 may protrude in a direction in which the two core side outer tabs 322 are directed toward each other. Meanwhile, in a more preferable example, the core side inner tab 324 may protrude in a direction away from another inner space S3 formed adjacent, in the circumferential direction C, to the inner space S3 in which the core side inner tab is formed.

Meanwhile, according to the present disclosure, the outer space S2 may communicate with an external space of the core body 100 in a state in which the filling member 400 is excluded from the rotor 10. It may be understood that regions adjacent to the outer space S2 in the core body 100 are spaced apart from each other based on the boundary of the outer space S2.

Meanwhile, according to the present disclosure, the core body 100 may be a single component formed integrally. It may be understood that the core body 100 is not divided into a plurality of portions physically spaced apart from one another by the plurality of magnet members 200 inserted into the core body 100, as described below.

More specifically, the magnet members 200 may be provided as a plurality of magnet members 200 spaced apart from one another in the circumferential direction C that surrounds the rotation axis A of the core body 100. In this case, the plurality of magnet members 200 may be disposed such that regions in which the two magnet members disposed adjacent to each other in the circumferential direction C are closest to each other are alternately formed at i) inner ends of the magnet members 200 and ii) outer ends of the magnet members 200 in the circumferential direction C. It may be understood that a shape in which the plurality of magnet members 200 are disposed in the circumferential direction C is an approximate star shape, and the two adjacent magnet members 200 are physically spaced apart from each other.

More specifically, in a section in which the region in which the two magnet members 200 disposed adjacent to each other in the circumferential direction C are closest to each other is formed at the inner ends of the magnet members 200, the inner space S3, which is formed in the insertion space S into which one of the two magnet members 200 is inserted, and the inner space S3, which is formed in the insertion space S into which the other of the two magnet members 200 is inserted, may be spaced apart from each other in parallel with the circumferential direction C.

Hereinafter, the shaft member 500 will be described in detail.

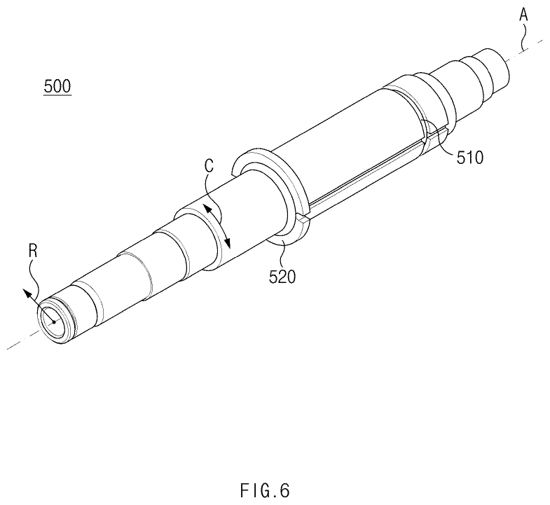

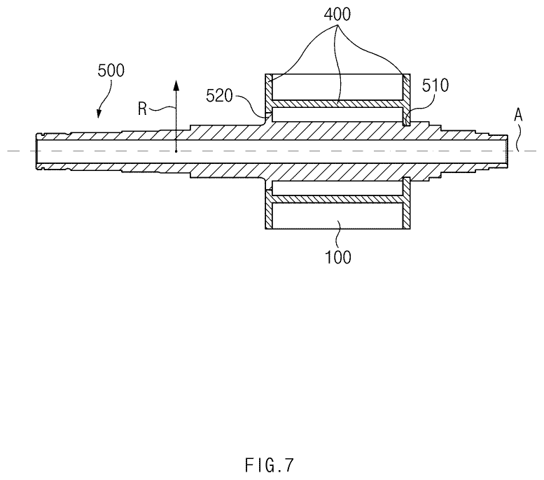

FIG. 6 is a perspective view of the shaft member in FIG. 1 in the embodiment of the present disclosure, and FIG. 7 is a cross-sectional view illustrating a state in which the rotor in FIG. 1 is cut in a direction including the rotation axis in the embodiment of the present disclosure.

With reference to FIGS. 6 and 7, the shaft member 500 according to the present disclosure may have a shaft groove 510 having a recessed shape and formed in the circumferential direction C that surrounds the rotation axis A, or a shaft protrusion region 520 having a protruding shape and formed in the circumferential direction C. More particularly, the shaft member 500 may have the shaft groove 510 and the shaft protrusion region 520.

Meanwhile, according to the present disclosure, the outer space S2 and the inner space S3 may be filled with the filling members 400. Furthermore, as illustrated in FIGS. 6 and 7, a part of the filling member 400 may also be formed on the outer surface of the core body 100. More specifically, portions of the filling member 400, which are formed on the outer surface of the core body 100, may be respectively formed on two opposite surfaces of the core body 100 based on the direction parallel to the rotation axis A. In this case, a part of a region of the filling member 400 formed on the outer surface of the core body 100 may be inserted into the shaft groove 510, and a part of a region of the filling member 400 formed on the outer surface of the core body 100 may be provided to be tightly attached to the shaft protrusion region 520. As described above, the filling member 400 may contain or be made of an adhesive plastic material. In this case, the filling member 400 may be tightly attached and bonded to the shaft groove 510 and the shaft protrusion region 520. For example, as illustrated in FIGS. 6 and 7, a region of the filling member 400, which is tightly attached to the shaft protrusion region 520, may be provided to be tightly attached to an outer surface of the shaft protrusion region 520 in a radial direction R perpendicularly intersecting the rotation axis A. According to the present disclosure, the portions of the filling member 400, which are provided to be tightly attached to the shaft groove 510 and the shaft protrusion region 520, may serve to fix the core body 100 and the magnet members 200 in an extension direction of the rotation axis A, such that it is possible to exclude a plate and a retainer for fixing a rotor in the related art.

Hereinafter, a rotor for a motor according to another embodiment of the present disclosure will be described with reference to the drawings.

### Rotor for Motor

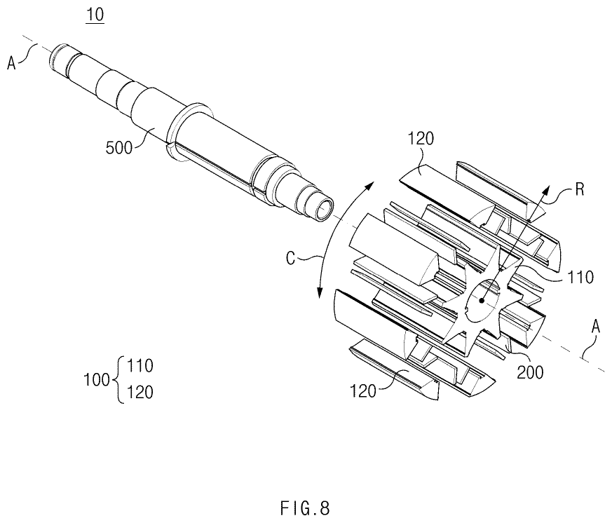

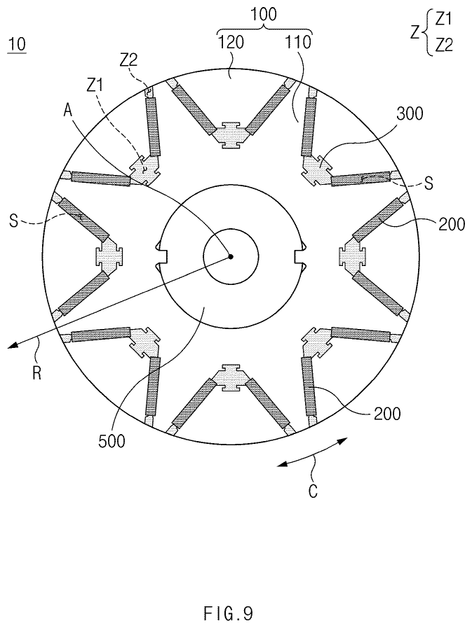

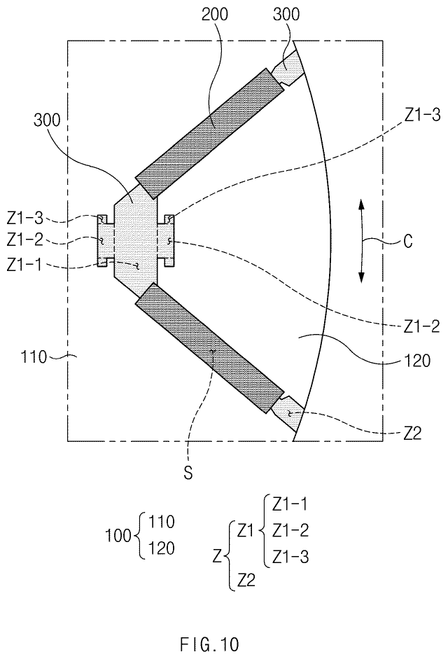

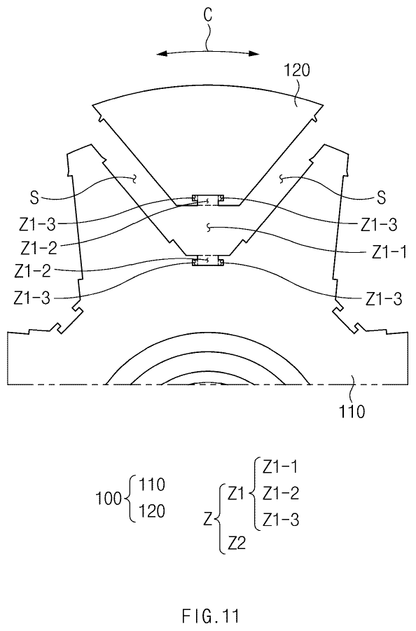

FIG. 8 is an exploded perspective view of the rotor in FIG. 1 in another embodiment of the present disclosure, and FIG. 9 is a view illustrating a state in which the rotor in FIG. 1 is cut in the direction perpendicular to the rotation axis in another embodiment of the present disclosure. FIG. 10 is an enlarged view illustrating the magnet member in FIG. 3 and the peripheral region of the magnet member in another embodiment of the present disclosure, and FIG. 11 is a view for explaining an insertion space and a filling space defined by an inner core region and an outer core region of a core body in another embodiment of the present disclosure.

With reference to FIGS. 1 and 8 to 11, the rotor 10 for a motor (hereinafter, referred to as a ‘rotor’) according to another embodiment of the present disclosure may include the core body 100 having the insertion spaces S and filling spaces Z therein, and the magnet members 200 inserted into the insertion spaces S. The magnet member 200 may be a permanent magnet. More specifically, the insertion spaces S may be provided as a plurality of insertion spaces S in the circumferential direction C of the rotor 10, and the filling spaces Z may be provided as a plurality of filling spaces Z in the circumferential direction C of the rotor 10.

In addition, the rotor 10 according to the present disclosure may further include the filling members 400 configured to fill the filling spaces Z. More specifically, among the spaces formed in the core body 100, the magnet member 200 may be accommodated in the insertion space S, and the filling member 300 may be accommodated in the filling space Z. Meanwhile, the filling member 300 may contain or be made of an adhesive plastic material. More particularly, the filling member 300 may contain or be made of an adhesive plastic material that is a curable material and has fluidity before the material is cured.

The filling member 300 according to the present disclosure may serve to fix the magnet member 200 to the core body 100. Therefore, the filling space Z may be formed at one side of the insertion space S and communicate with the insertion space S so that one side of the filling member 300 may be joined or coupled to the magnet member 200. In addition, as described below, a partial region of the filling member 300 may be provided to be tightly attached to the outer surface of the core body 100. In this case, the filling member 300 may serve as a plate or retainer that is a component for supporting a core body of a rotor in the related art.

Meanwhile, as illustrated in FIGS. 1 and 8, the rotor 10 according to the present disclosure may further include the shaft member 500 inserted into the axial space extending along the rotation axis A of the core body 100. More specifically, the core body 100 may be fixed to the shaft member 500. Meanwhile, the above-mentioned rotation axis A may be considered the rotation axis for the shaft member 500 and the rotor 10 as well as the core body 100.

Meanwhile, the core body 100 according to the present disclosure may be configured by assembling a plurality of components provided separately from one another. More specifically, with reference to FIGS. 8 to 12, the core body 100 may include an inner core region 110 provided at an inner side of the rotor based on the radial direction R, and outer core regions 120 provided separately from the inner core region 110 and provided at an outer side of the inner core region 110 based on the radial direction R. In this case, the insertion spaces S and the filling spaces Z may be formed in regions in which the inner core region 110 and the outer core regions 120 face one another.

Meanwhile, the filling space Z may include a first filling space Z1. For example, the filling space Z1 may be formed to be connected to an inner end of the insertion space S based on the radial direction R.

In this case, according to the present disclosure, the first filling space Z1 may include a first-first filling space Z1-1 extending in a direction in which the first-first filling space Z1-1 connects the two magnet members 200 adjacent to each other in the circumferential direction C, and first-second filling spaces Z1-2 configured to communicate with the first-first filling space Z1-1 and extending in a direction intersecting the first-first filling space Z1-1. More specifically, the first-second filling space Z1-2 may extend in the radial direction R from at least one side of the first-first filling space Z1-1. More particularly, as illustrated in FIGS. 8 to 11, the first-second filling spaces Z1-2 may respectively extend from two opposite sides of the first-first filling space Z1-1 based on the radial direction R. In this case, it may be understood that the first filling space Z1 includes a region having an approximate plus (+) shape.

Meanwhile, the above-mentioned inner core region 110 may be formed as a single member, whereas the outer core regions 120 may be provided as a plurality of members. For example, as illustrated in FIGS. 8 and 9, the inner core region 110 may have a shape in which protruding sections and recessed sections are alternately disposed along a circumferential region C. The plurality of outer core regions 120 may be inserted into spaces defined by the recessed sections of the inner core region 110. In this case, the first filling space Z1 may be provided to face an inner end of the outer core region 120 based on the radial direction R, i.e., an inner end of the recessed section based on the radial direction R. It may be understood that an inner boundary of the first filling space Z1 based on the radial direction R is defined by the inner end of the outer core region 120 based on the radial direction R.

In case that the first filling space includes the first-first filling space and the first-second filling spaces as described above, it is possible to prevent the filling member 300 from separating during the process of curing the filling member 300, thereby increasing a coupling force between the filling member 300 and the magnet member 200 or between the filling member 300 and the core body 100.

With continued reference to FIGS. 8 to 11, the first filling space Z1 may further include a first-third filling space Z1-3 extending from one end of the first-second filling space Z1-2 in a direction intersecting the direction in which the first-second filling space Z1-2 extends from the first-first filling space Z1-1. More specifically, the direction (e.g., the radial direction R) in which the first-second filling space Z1-2 extends from the first-first filling space Z1-1 and the direction (e.g., the circumferential direction C) in which the first-third filling space Z1-3 extends from the first-second filling space Z1-2 may perpendicularly intersect each other. The first-third filling space Z1-3 may extend in the circumferential direction C from at least one end of the first-second filling space Z1-2. More particularly, as illustrated in FIGS. 9 to 11, the first-third filling spaces Z1-3 may extend from two opposite ends of the first-second filling space Z1-2 based on the circumferential direction C. Most particularly, the first-third filling spaces Z1-3 may be provided at the two opposite sides end of the first-second filling space Z1-2 based on the circumferential direction C, and the first-second filling spaces Z1-2 may be respectively provided at the two opposite ends of the first-first filling space Z1-1 based on the radial direction R. It may be understood that four first-third filling spaces Z1-3 correspond to one first-first filling space Z1-1.

Meanwhile, the first-third filling space Z1-3 may be formed to be spaced apart from the first-first filling space Z1-1 in the radial direction R. More specifically, a width of the first-third filling space Z1-3 in the radial direction R may be smaller than a width of the first-first filling space Z1-1 in the radial direction R, and a width of the first-third filling space Z1-3 in the circumferential direction C may be smaller than a width of the first-first filling space Z1-1 in the circumferential direction C. Meanwhile, unlike the first-first filling space Z1-1 physically connected to the magnet member 200, the first-third filling space Z1-3 may be physically spaced apart from the magnet member 200 adjacent to the first-third filling space Z1-3. Therefore, a portion of the filling member 300, which fills the first-third filling space Z1-3, may be physically in contact only with the outer core region 120.

With continued reference to FIGS. 8 and 9, the filling space Z may further include a second filling space Z2 provided to face the first filling space Z1 with the insertion space S interposed therebetween. More specifically, the second filling space Z2 may communicate with an outer end of the insertion space S based on the radial direction R. Meanwhile, the second filling space Z2 may communicate with an external space of the rotor 10 outward in the radial direction R. More specifically, according to the present disclosure, there may be no component corresponding to a winding member that surrounds an outer region of a rotor in the related art. In particular, according to the present disclosure, the geometric shapes of the first filling space Z1 and the second filling space Z2 may ensure sufficient coupling forces between the components of the rotor only by using the bonding force of the filling member 300, such that the component corresponding to a winding member may not be required.

Meanwhile, according to the present disclosure, the plurality of magnet members 200 provided in the rotor 10 may be provided to be spaced apart from one another in the circumferential direction C. More specifically, the plurality of magnet members 200 may be disposed such that the regions in which the two magnet members 200 disposed adjacent to each other in the circumferential direction C are closest to each other are alternately formed at i) the inner ends of the magnet members 200 based on the radial direction R and ii) the outer ends of the magnet members 200 based on the radial direction R in the circumferential direction C. It may be understood that a shape in which the plurality of magnet members 200 are disposed in the circumferential direction C is an approximate star shape, and the two adjacent magnet members 200 are physically spaced apart from each other.

More specifically, in a section in which the region in which the two magnet members 200 disposed adjacent to each other in the circumferential direction C are closest to each other is formed at the outer ends of the two magnet members 200 based on the radial direction R, the two second filling spaces Z2 respectively provided at the outer sides of the two magnet members 200 based on the radial direction R may be spaced apart from each other in the circumferential direction C.

Hereinafter, the shaft member 500 according to another embodiment of the present disclosure will be described in detail.

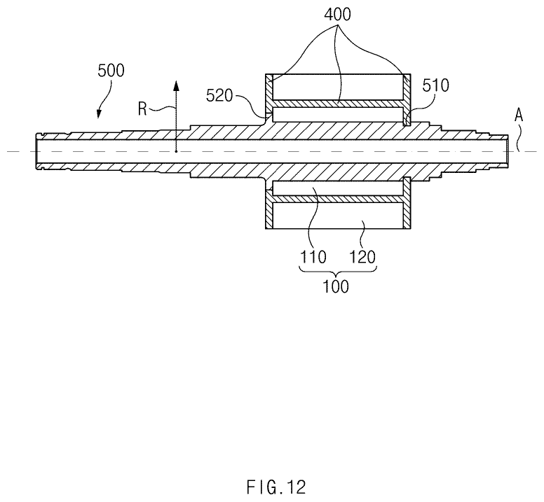

FIG. 12 is a cross-sectional view illustrating a state in which the rotor in FIG. 1 is cut in the direction including the rotation axis in another embodiment of the present disclosure.

Meanwhile, as described above, the core body 100 of the rotor may have the axial space extending along the rotation axis A of the core body. In this case, as illustrated in FIGS. 6 and 12, the shaft member 500 according to another embodiment of the present disclosure may have the shaft groove 510 having a recessed shape and formed in the circumferential direction C that surrounds the rotation axis A, or the shaft protrusion region 520 having a protruding shape and formed in the circumferential direction C. More particularly, the shaft member 500 may have the shaft groove 510 and the shaft protrusion region 520.

Meanwhile, according to the present disclosure, as illustrated in FIGS. 6 and 12, a part of the filling member 300 may also be formed on the outer surface of the core body 100. More specifically, portions of the filling member 300, which are formed on the outer surface of the core body 100, may be respectively formed on two opposite surfaces of the core body 100 based on the direction parallel to the rotation axis A. In this case, a part of a region of the filling member 300 formed on the outer surface of the core body 100 may be inserted into the shaft groove 510, and a part of a region of the filling member 300 formed on the outer surface of the core body 100 may be provided to be tightly attached to the shaft protrusion region 520. As described above, the filling member 300 may contain or be made of an adhesive plastic material. In this case, the filling member 300 may be tightly attached and bonded to the shaft groove 510 and the shaft protrusion region 520. For example, as illustrated in FIGS. 6 and 12, a region of the filling member 300, which is tightly attached to the shaft protrusion region 520, may be provided to be tightly attached to an outer surface of the shaft protrusion region 520 in a radial direction R perpendicularly intersecting the rotation axis A. According to the present disclosure, the portions of the filling member 300, which are provided to be tightly attached to the shaft groove 510 and the shaft protrusion region 520, may serve to fix the core body 100 and the magnet members 200 in an extension direction of the rotation axis A, such that it is possible to exclude a plate and a retainer for fixing a rotor in the related art.

The present disclosure has been described with reference to the limited embodiments and the drawings, but the present disclosure is not limited thereby. The present disclosure may be carried out in various forms by those skilled in the art, to which the present disclosure pertains, within the technical spirit of the present disclosure and the scope equivalent to the appended claims.

What is claimed is:

1. A rotor comprising:
a core body having an insertion space S therein; and
a magnet member inserted into the insertion space S,
wherein a tab portion is formed on an inner surface of the core body or one side surface of the magnet member that defines a boundary of the insertion space S, and the tab portion protrudes toward a space of the insertion space S other than a space into which the magnet member is inserted.

2. The rotor of claim 1, further comprising:
a filling member configured to fill at least a part of the space of the insertion space S other than the space into which the magnet member is inserted,
wherein the filling member is provided to surround the tab portion.

3. The rotor of claim 1, wherein the tab portion comprises a magnet side tab portion provided on one side surface of the magnet member and protruding toward the space of the insertion space S other than the space into which the magnet member is inserted.

4. The rotor of claim 3, wherein the insertion space S comprises:
a main space S1 that is a space occupied by the magnet member;
an outer space S2 formed outward of the main space S1; and
an inner space S3 formed inward of the main space S1, and
wherein the magnet side tab portion protrudes from an end of the magnet member that faces the inner space S3.

5. The rotor of claim 4, wherein a direction in which the magnet side tab portion protrudes is parallel to a direction in which the main space S1 extends.

6. The rotor of claim 3, wherein the insertion space S comprises:
a main space S1 that is a space occupied by the magnet member;
an outer space S2 formed outward of the main space S1; and
an inner space S3 formed inward of the main space S1, and
wherein the magnet side tab portion protrudes from an end of the magnet member that faces the outer space S2.

7. The rotor of claim 1, wherein the tab portion comprises a core side tab portion formed on the inner surface of the core body that defines the boundary of the insertion space S, and the core side tab portion protrudes toward the space of the insertion space S other than the space into which the magnet member is inserted.

8. The rotor of claim 7, wherein the insertion space S comprises:
a main space S1 that is a space occupied by the magnet member;
an outer space S2 formed outward of the main space S1; and
an inner space S3 formed inward of the main space S1, and
wherein the core side tab portion comprises a core side outer tab protruding from the inner surface of the core body that defines the outer space S2.

9. The rotor of claim 8, wherein a direction in which the core side outer tab protrudes intersects a direction in which the main space S1 extends.

10. The rotor of claim 8, wherein the core side outer tab is provided as two core side outer tabs protruding from the inner surface that defines one outer space S2, and the two core side outer tabs protrude in a direction in which the two core side outer tabs are directed toward each other.

11. The rotor of claim 8, wherein the insertion space S comprises:
a main space S1 that is a space occupied by the magnet member;
an outer space S2 formed outward of the main space S1; and
an inner space S3 formed inward of the main space S1, and
wherein the core side tab portion comprises a core side inner tab protruding from the inner surface of the core body that defines the inner space S3.

12. The rotor of claim 11, wherein a direction in which the core side inner tab protrudes is parallel to a circumferential direction C that surrounds a rotation axis A of the core body.

13. The rotor of claim 1, wherein the core body is formed integrally.

14. The rotor of claim 13, wherein the magnet member is provided as a plurality of magnet members spaced apart from one another in a circumferential direction C that surrounds a rotation axis A of the core body, and
wherein the plurality of magnet members are disposed such that regions in which the two magnet members disposed adjacent to each other in the circumferential direction C are closest to each other are alternately formed at inner ends of the magnet members and outer ends of the magnet members in the circumferential direction C.

15. The rotor of claim 14, wherein in a section in which the region in which the two magnet members disposed adjacent to each other in the circumferential direction C are closest to each other is formed at the inner ends of the magnet members, the inner space S3, which is formed in the insertion space S into which one of the two magnet members is inserted, and the inner space S3, which is formed in the insertion space S into which the other of the two magnet members is inserted, are formed to be spaced apart from each other in the circumferential direction C.

16. The rotor of claim 15, wherein the insertion space S comprises:
a main space S1 that is a space occupied by the magnet member;
an outer space S2 formed outward of the main space S1; and
an inner space S3 formed inward of the main space S1,
wherein the core side tab portion comprises a core side inner tab protruding from the inner surface of the core body that defines the inner space S3, and
wherein the core side inner tab protrudes in a direction away from another inner space S3 formed adjacent, in the circumferential direction C, to the inner space S3 in which the core side inner tab is formed.

17. The rotor of claim 2, further comprising:
a shaft member inserted into an axial space formed along a rotation axis A of the core body,
wherein the shaft member has a shaft groove having a recessed shape and formed in a circumferential direction C that surrounds the rotation axis A,
wherein a part of the filling member is formed on an outer surface of the core body, and
wherein a part of a region of the filling member formed on the outer surface of the core body is inserted into the shaft groove.

18. The rotor of claim 17, wherein the shaft member has a shaft protrusion region having a protruding shape and formed in the circumferential direction C, and
wherein a part of the region of the filling member formed on the outer surface of the core body is provided to be attached to the shaft protrusion region.

19. The rotor of claim 18, wherein the region of the filling member attached to the shaft protrusion region is provided to be attached to an outer surface of the shaft protrusion region in a radial direction R perpendicularly intersects the rotation axis A.

20. The rotor of claim 2, wherein the filling member contains an adhesive plastic material.
